(19) United States
(12) Patent Application Publication
(10) Pub. No.: US 2003/0102747 A1
(43) Pub. Date: Jun. 5, 2003

(54) Use of zirconia balls for the landing bearings in molecular drag pumps on magnetic bearings

(75) Inventors: Rainer Mathes, St Julien En Genevois (FR); Andre Bouille, Annecy (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/278,804

(22) Filed: Oct. 24, 2002

(30) Foreign Application Priority Data
Oct. 25, 2001 (FR) 01 13 803

(51) Int. Cl. H02K 7/09

(52) U.S. Cl. 310/90.5

(57) ABSTRACT

According to the invention, a landing bearing for a vacuum pump comprises a rotor ball race and a coaxial stator ball race with rolling elements placed between them, housed one after another and rolling on respective rolling tracks of the rotor and stator ball races. The rolling elements comprise a succession of rolling elements having outside surfaces made of zirconium dioxide. This reduces the resistance of the landing bearing to acceleration, while nevertheless providing good resistance to chemical attacks from process gases and plasmas.

The present invention relates to the suspension of vacuum pump rotors, in particular the suspension of rotors in molecular drag pumps.

### BACKGROUND OF THE INVENTION

In a vacuum pump, a rotor that rotates in a stator is held by magnetic bearings which, in normal operation, maintain the rotor in a centered radial position inside the stator to within normal centered holding accuracy and without mechanical contact between the rotor and the stator. Magnetic bearings comprise electromagnets powered electrically by appropriate circuits to servo-control the radial position of the rotor in the stator.

The effectiveness with which the rotor is held radially inside the stator is determined by the force delivered by the electromagnets, and this requires the electromagnets to be powered with sufficient electrical energy.

A fault can sometimes occur, as can the inability of magnetic bearings to operate normally, e.g. in the event of a sudden large stress on the rotor or if there is an interruption in the supply of electricity to the electromagnets. Under such circumstances, the magnetic bearings no longer act to center the rotor and a “landing” stage occurs in which the rotor changes from being held in a state without mechanical contact to being held in a state with mechanical contact. During such landing, the rotor tends to come into contact with the stator. Because the rotor is spinning very fast, e.g. at more than 30,000 revolutions per minute (rpm) in present molecular drag pumps, such contact can lead to the vacuum pump being destroyed.

To solve this problem, vacuum pumps have already been fitted with secondary mechanical bearings for landing purposes based on rolling bearings which, in the event of the magnetic bearings failing to operate normally, restrict radial displacements of the rotor within the stator and ensure that the rotor remains approximately centered, with radial movement of the rotor being restricted to a value that is smaller than the air gap of the magnetic bearings. An example of such a vacuum pump is disclosed in document GB 2 348 680 A. The material constituting the rolling elements of the bearings for landing purposes is not disclosed.

Secondary mechanical bearings for landing purposes are situated inside the vacuum pump. Consequently, they can be exposed to corrosive gases or plasmas passing through the vacuum pump while it is being used in processes for manufacturing semiconductors. Such corrosive gases or plasmas are liable to cause the secondary mechanical bearing for landing purposes to be degraded in the short or long term, in which case it is no longer capable of performing its function of centering the rotor approximately in the event of landing.

There therefore exists a need to increase the ability of the secondary mechanical bearing for landing purposes to withstand chemical attack from process gases or plasmas. For this purpose, secondary mechanical bearings for landing purposes have been used with success in which the bearings comprise stainless steel ball races associated with balls that are also made of stainless steel.

However, it has been found that the number of landings that such stainless steel mechanical bearings can perform without becoming significantly degraded remains small, thus reducing the reliability of the vacuum pump and increasing the frequency of maintenance operations. It turns out that the lack of reliability of mechanical bearings for landing purposes based on stainless steel balls is the result of the resistance opposed by the landing bearing to acceleration.

In normal operation of magnetic bearings in which mechanical bearings for landing purposes are mounted on the stator, the balls of the landing bearings are stationary, being secured to the stator; in the event of the operation of the magnetic bearings being interrupted, the rotor comes into contact with the still stationary inside ball races of the mechanical bearings for landing purposes and sets the inside ball races of the bearings and the rolling elements situated between the inside and the outside ball races into rotation; because the landing bearing resists being accelerated, the speed of rotation of the inside ball races increases only progressively, causing slip to occur between the rotor and the inside ball races of the mechanical bearings for landing purposes. Inevitably, this gives rise to wear on the respective contacting surfaces of the rotor and of the inside ball races of the mechanical bearings for landing purposes, thereby progressively increasing clearance and reducing the effectiveness of the device; in addition, rubbing between the various pieces can sometimes cause shavings or filings to appear, thereby running the risk of jamming the rolling elements of the mechanical bearing.

Wear phenomena and the consequences thereof are made worse when the inside ball races of the mechanical bearings for landing purposes are subjected to phenomena that impede rapid acceleration in rotation thereof, so that they do not reach the speed of rotation of the rotor as soon as possible.

In this respect, a first cause of resistance to acceleration by a landing bearing is its own inertia. Attempts have been made to reduce the inertia of landing bearings by using rolling elements of smaller mass. Proposals have thus been made to replace traditional rolling elements such as stainless steel balls with balls made of ceramic material, of density that is much lower than that of steel.

The rolling elements must be capable of withstanding very high speeds of rotation, giving rise to severe mechanical stresses, so the manufacturers of balls for bearing balls recommend using silicon nitride as the ceramic. That ceramic presents the advantage of low density, thus ensuring very low inertia. That ceramic also presents a low coefficient of expansion, which is advantageous for guaranteeing proper operation of the secondary mechanical bearing for landing purposes under the usual temperature conditions. That ceramic also presents relatively high thermal conductivity, thus making it easier to cool the secondary mechanical bearing for landing purposes.

Unfortunately, ceramics, and in particular silicon nitride, are degraded quickly by the gases and plasmas used in novel processes by machines for manufacturing semiconductors. Such machines use high density plasmas in combination with gases such as NF₃ which, in their atomic form (F⁺), etch the silicon nitride Si₃N₄ ceramic. It is found that such secondary mechanical bearings for landing purposes using silicon nitride balls need to be changed after no more than 6 months' use because of the corrosion to which the balls are subjected.

### OBJECTS AND SUMMARY OF THE INVENTION

The problem of the present invention is that of devising a novel structure for a secondary mechanical rolling bearing for landing purposes in a high speed vacuum pump, which presents longer lifetime so as to enable a larger number of landings and a longer duration of fault-free operation under the conditions of use in the presence of aggressive plasmas or gases.

For this purpose, the invention provides a particular structure serving simultaneously to reduce resistance to acceleration of the landing bearing as much as possible, and to provide satisfactory resistance to chemical attack from process gases and plasmas used in semiconductor manufacture.

To achieve these objects, and others, the invention provides a structure of vacuum pump comprising a rotor rotatably mounted in a stator with at least one radial Magnetic bearing which, in normal operation, holds the rotor in a radially centered position inside the stator, and with at least one mechanical bearing for landing purposes with a landing rolling bearing which, in the event of the radial magnetic bearings not functioning normally, restricts the radial displacements of the rotor inside the stator by ensuring that the rotor is centered approximately, radial clearance being provided between one of the ball races of the rotor or the stator and a corresponding bearing surface of the rotor or the stator, the landing bearing comprising:

a rotor ball race and a coaxial stator ball race, which define between them a rolling housing,

rolling elements housed one after another in the rolling housing and rolling on respective rolling tracks of the rotor and stator ball races;

according to the invention, at least some of the rolling elements have outside surfaces made of zirconium dioxide, providing both sufficient mechanical strength and protection against chemical attacks.

Zirconia, i.e. zirconium dioxide, is generally used for bearings in which speeds of rotation are very low. The manufacturers of bearing balls never recommend using zirconium dioxide when speeds of rotation are high, giving rise to severe mechanical stresses. Several characteristics of zirconium dioxide are unfavorable in an application to high speed bearings, thus a priori dissuading anybody from using them in landing bearings for a molecular drag pump: its coefficient of expansion is relatively high, about three times that of silicon nitride, which is usually recommended; its density is higher, thereby increasing inertia; and its thermal conductivity is unfavorable for cooling a mechanical bearing.

Surprisingly, and in spite of those unfavorable parameters, the inventors have used zirconium dioxide with success in obtaining satisfactory mechanical performance, similar to that of bearings having silicon nitride balls, while also obtaining great resistance to corrosion by gases and plasmas such as atomic fluorine.

In an advantageous embodiment, the rolling elements having zirconium dioxide outside surfaces are solid structures, made entirely out of zirconium dioxide.

In a simplified embodiment, the rolling elements are spherical balls.

In a first embodiment, the rolling elements all have zirconium dioxide outside surfaces.

In a second embodiment, the rolling elements comprise an alternating succession of steel rolling elements and of zirconium dioxide rolling elements.

Preferably, the steel rolling elements are made of stainless steel.

The rolling tracks may be made of stainless steel.

The rolling elements may all have substantially the same diameter when the bearing is under normal operating temperature conditions. Normal operating temperatures usually lie in the range about 60° C. to 90° C. For this purpose, provision is made for the diameter of the zirconium dioxide rolling elements at ambient temperature to be slightly greater than the diameter of the steel rolling elements, in order to compensate for the differences between the coefficients of thermal expansion of zirconium dioxide and steel.

A vacuum pump according to the invention has at least one mechanical bearing for landing purposes with a landing rolling bearing as defined above.

### BRIEF DESCRIPTION OF THE DRAWINGS

Other objects, characteristics, and advantages of the present invention appear from the following description of particular embodiments, given with reference to the accompanying figures, in which:

FIG. 1 is a general longitudinal section view of a vacuum pump in which the rotor is held by magnetic bearings and by associated mechanical bearings for landing purposes;

FIG. 2 is a detail section view on a larger scale of zone A in FIG. 1, showing half of a rolling mechanical bearing for landing purposes according to an embodiment of the present invention;

FIG. 3 is a face view on an enlarged scale of a landing bearing according to an embodiment of the invention; and

FIG. 4 is a perspective view in fragmentary section of the FIG. 3 landing bearing.

### MORE DETAILED DESCRIPTION

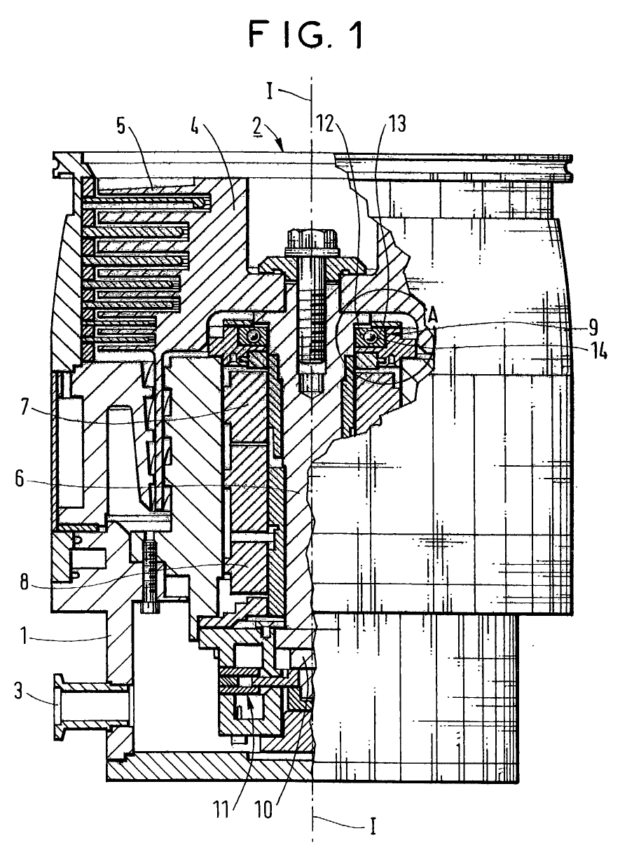

In the embodiment of FIG. 1, a vacuum pump generally comprises a stator 1 having an axial suction inlet 2 and a radial delivery outlet 3. A rotor 4 is mounted to rotate axially inside the stator 1 about the longitudinal axis I-I. The rotor 4 carries a suction system represented by fins 5, and has a shaft 6 turning in bearings of the stator 1. In the figure, there can be seen two radial magnetic bearings 7 and 8, and two landing mechanical bearings 9 and 10 having landing rolling bearings that act radially. There can also be seen an axial magnetic bearing 11.

In normal operation, i.e. in the absence of any excessive force on the shaft 6 of the pump and in the event of the magnetic bearings operating normally, these bearings hold the rotor 4 properly in a centered axial position, and the mechanical landing bearings 9 and 10 do not touch the shaft 6.

In the mechanical landing bearing 9, there can be seen a rotor ball race 12 placed close to and around the shaft 6 of the rotor 4, and a coaxial stator ball race 13 placed in contact with the stator 1. The rotor and stator ball races 12 and 13 define between them a rolling housing 19. Rolling elements 14 such as balls, needles, or any other known type of rolling element, are placed in the rolling housing 19 between the rotor ball race 12 and the coaxial stator ball race 13 in order to constitute a rolling bearing allowing relative axial rotation to take place between the two ball races 12 and 13.

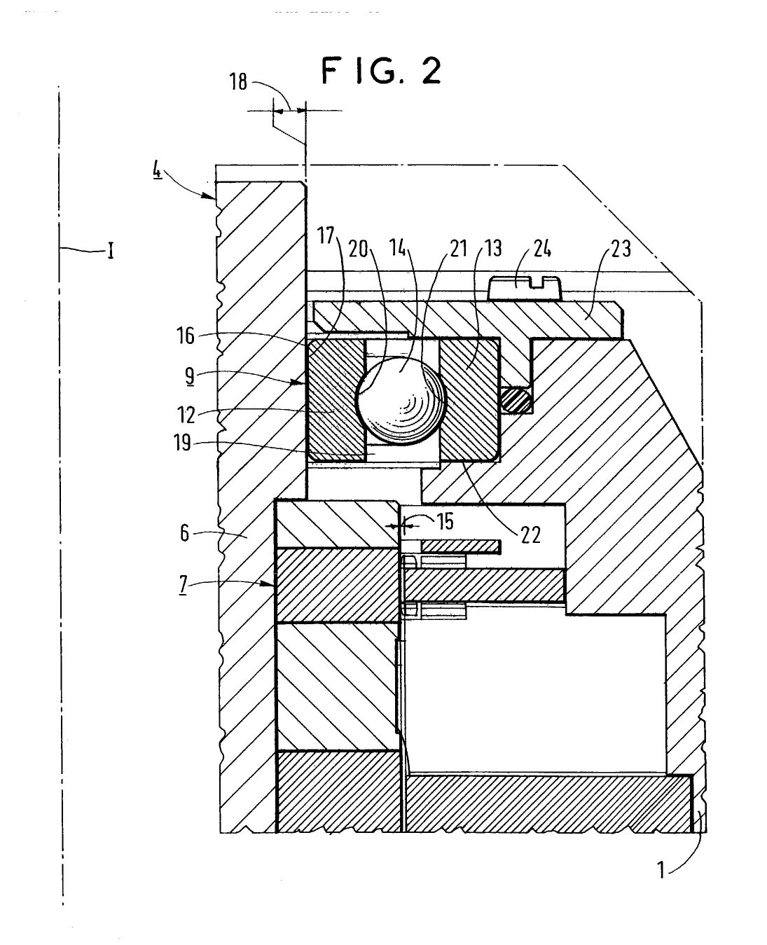

Reference is now made to FIG. 2 showing half of a mechanical landing bearing 9 in greater detail and on a larger scale in position between the shaft 6 of the rotor 4 and a corresponding portion of the stator 1. There can be seen a rolling element 14 in the rolling housing 19 between the rotor ball race 12 and the coaxial stator ball race 13. The rolling element 14 runs on respective rolling tracks 20 and 21 of the rotor and stator ball races 12 and 13. There can also be seen the radial magnetic bearing 7 which, in normal operation, serves to center the shaft 6 of the rotor 4 in the stator 1, leaving an empty annular air gap 15, which defines the maximum clearance for radial displacement of the shaft 6 inside the stator 1. Under usual conditions, the width of the air gap 15 can be about 0.2 millimeters (mm) to 0.4 mm, for example. The purpose of the mechanical landing bearing 9 is to limit radial displacement of the shaft 6 of the rotor 4 inside the stator 1 to a value which is considerably smaller than the air gap 15, so as to avoid damaging the magnetic bearings when landing takes place.

Between the inside annular face 16 of the rotor ball race 12 and a first corresponding bearing surface 17 of the rotor 4, radial clearance 18 is provided, that is considerably smaller than the air gap 15, but only slightly greater than the accuracy with which the rotor 4 is normally held centered by the radial magnetic bearing(s) 7. This accuracy with which the rotor 4 is normally held centered is generally very good, being within a few microns.

The coaxial stator ball race 13 is engaged in and strongly braked by, or prevented from rotating in, an end housing of the stator 1, between an axial shoulder 22 and a fixing ring 23 that is fixed on the stator 1 and held in place by screws, with the head 24 of one screw being visible in the figure.

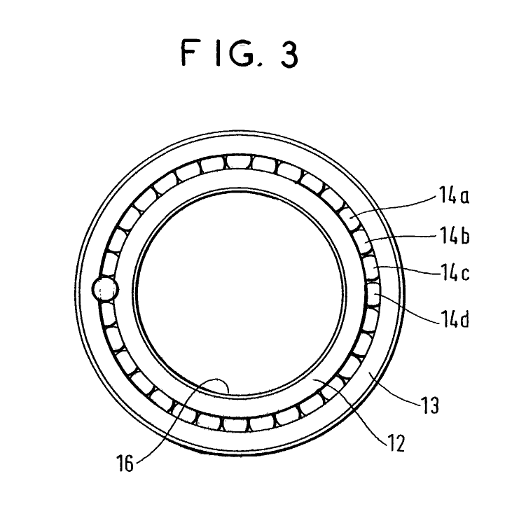

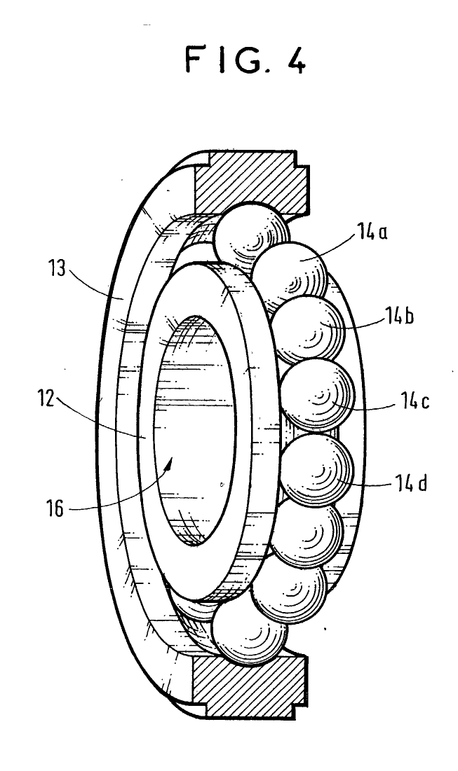

In the embodiment shown in FIGS. 3 and 4, the landing bearing has rolling elements in the form of spherical balls.

According to a first possibility, the rolling elements all have outside surfaces made of zirconium dioxide (ZrO₂).

According to a second possibility, the rolling elements comprise an alternating succession of rolling elements having an outside surface made of steel and rolling elements having an outside surface made of zirconium dioxide. Thus, the rolling elements 14a and 14c have steel outside surfaces while the rolling elements 14b and 14d have zirconium dioxide outside surfaces.

For the steel rolling elements 14a and 14c, it is advantageous to use a stainless steel.

During landing, the rolling elements 14a-14d enter into rotation, and adjacent rolling elements such as elements 14a and 14b come into contact one against the other via portions of their peripheral surfaces, thus leading to friction. Zirconium dioxide encourages sliding and therefore reduces friction forces, that prevent a rapid acceleration of the landing bearing.

The rolling tracks 20 and 21 (FIG. 2) may be made of stainless steel.

In certain applications, it may be preferable to have a plurality of rolling elements 14a, 14c made of steel because it is a good conductor of heat, thereby maintaining sufficient capacity for cooling the rotor. For this purpose, provision is made to ensure that the steel rolling elements 14a, 14c remain in contact with the rolling tracks 20 and 21 under the temperature conditions of normal operation.

In other words, under such temperature conditions of normal operation, the diameter of the zirconium dioxide rolling elements 14b, 14d should preferably be no greater than the diameter of the steel rolling elements 14a, 14c.

During landing, operation takes place as follows: initially, the rotor ball race 12 does not touch the shaft 6, which spins at high speed about its longitudinal axis I-I. When the radial magnetic bearings such as the bearing 7 cease to operate, the rotor 4 may move radially across the first radial clearance 18 until it makes contact with the rotor ball race 12, which is initially stationary and which is thus entrained to rotate and in turn entrains the rolling elements 14 in rotation. The coaxial stator ball race 13 is prevented from rotating in the stator 1, or is at least braked thereby.

Because of inertia and friction in the landing bearing, the rotor ball race 12 does not instantaneously take up the high speed of rotation of the rotor 4. Rubbing therefore occurs between the bearing surface 17 of the rotor 4 and the corresponding inside annular face 16 of the rotor ball race 12. Because of the reduction in the friction that exists between adjacent rolling elements 14, and because of the low inertia of the rolling elements 14, the rotor ball race 12 can accelerate quickly, thereby reducing the length of time during which rubbing occurs between the bearing surface 17 of the rotor 4 and the inside annular face 16 of the rotor ball race 12. Simultaneously, the zirconium dioxide rolling elements 14 present good resistance to chemical attacks from process gases and plasmas.

The invention is not limited to the embodiments described explicitly above, but includes any variants and generalizations coming within the skill of the person skilled in the art.

What is claimed is:

1/ A vacuum pump comprising a rotor rotatably mounted in a stator with at least one radial magnetic bearing which, in normal operation, holds the rotor in a centered radial position inside the stator, and with at least one landing mechanical bearing having a landing ball bearing which, in the event of the radial magnetic bearing failing to operate normally, restricts radial displacements of the rotor inside the stator by ensuring that the rotor remains approximately centered, radial clearance being provided between one of the rotor and stator ball races and a corresponding bearing surface of the rotor or of the stator, the landing ball bearing comprising:
a rotor ball race and a coaxial stator ball race, which define between them a rolling housing, and
rolling elements housed one after another in the rolling housing and rolling on respective rolling tracks of the rotor and stator ball races,
wherein at least some of the rolling elements have outside surfaces made of zirconium dioxide providing both sufficient mechanical strength and protection against chemical attacks.

2/ A vacuum pump according to claim 1, wherein said rolling elements having zirconium dioxide outside surfaces are solid structures made entirely out of zirconium dioxide.

3/ A vacuum pump according to claim 1, wherein the rolling elements are spherical balls.

4/ A vacuum pump according to claim 1, wherein the rolling elements all have zirconium dioxide outside surfaces.

5/ A vacuum pump according to claim 1, wherein the rolling elements comprise an alternating succession of steel rolling elements and of zirconium dioxide rolling elements.

6/ A vacuum pump according to claim 5, wherein the steel rolling elements are made of stainless steel.

7/ A vacuum pump according to claim 5, wherein the diameter of the zirconium dioxide rolling elements is substantially equal to the diameter of the steel rolling elements under the temperature conditions of normal operation.

8/ A vacuum pump according to claim 1, wherein the rolling tracks are made of stainless steel.
